(19) United States
(12) Patent Application Publication
(10) Pub. No.: US 2007/0202288 A1
(43) Pub. Date: Aug. 30, 2007

(54) Process Of Making An Absorbent Material From Waste Goods And The Product Of The Process

(76) Inventor: Patricia M. Gearin, St Paul Park, MN (US)

Correspondence Address: GRAY, PLANT, MOOTY, MOOTY & BENNETT, P.A., P.O. BOX 2906, MINNEAPOLIS, MN, 55402-0906, US

(21) Appl. No.: 11/578,473

(22) PCT Filed: Apr. 11, 2005
(86) PCT No.: PCT/US05/12435

§ 371 Date: Oct. 13, 2006

Related U.S. Application Data
(60) Provisional application No. 60/561,846, filed on Apr. 14, 2004.

(51) Int. Cl. B32B 33/00

(52) U.S. Cl. 428/40.1

(57) ABSTRACT

A process of making an absorbent. The process is comprised of sorting footwear into categories (2), proportionally mixing the categories of footwear (4), shredding the footwear (3a), and removing metal and chromate from the footwear (6). Embodiments of the categories are women's regular, women's dark, men's, children's, tennis, and winter boot footwear. The footwear may be shredded to a first predetermined size (3) and then the metal may be removed (6). The footwear with the metal removed may then be again shredded to a second predetermined size (7), which is smaller than the first predetermined size, and the chromate may be removed (9). Alternatively, the footwear may be shredded to the second predetermined size and both the metal and chromate may be removed.

### CROSS-REFERENCE TO RELATED APPLICATION

This application claims the benefit of pending U.S. provisional patent application No. 60/561,846 filed Apr. 14, 2004.

### FIELD OF TECHNOLOGY

The technology described in this specification relates to a process of making absorbent material from waste goods and the product of the process.

### DESCRIPTION OF THE DRAWINGS

Embodiments of the process of making absorbent material from waste goods and the product of the process are illustrated in the accompanying drawings, in which:

FIG. 1 is a diagram of the flow of an embodiment of the process of making an absorbent material from waste goods;

FIG. 2 is a diagram of the flow of another embodiment of the process of making an absorbent material from waste goods; and

FIG. 3 is a photograph of an embodiment of the finished product made by the process.

### DESCRIPTION OF EMBODIMENTS OF THE TECHNOLOGY

Absorbent materials for removal of fluids is, and has been, a necessary product throughout the industrial age. Demand for absorbent materials has grown dramatically since the advent of pollution control. Absorbent materials are ubiquitous. They are used in all manner of ways. Probably the most notable use of absorbents is for removal of petroleum products—especially to remediate spills on land and water. Another example of their usage is to soak up petroleum products from the floors of manufacturing facilities, which result from the daily dripping of oil products used to maintain the smooth running of machinery.

Commercially available absorbent's are made of substances such as cellulose, clay, and polypropylene, as well as other substances. Most of these substances have drawbacks. For example, cellulose requires further demands on our dwindling forests; clay dust is a harmful inhalant; and polypropylene is an oil based product.

The technology described in this specification uses materials that (a) do not increase demand on natural resources; (b) are not harmful to health; and (c) are not expensive. The raw materials of the embodiments described are waste products. In particular, materials such as discarded footwear when processed according to the embodiments described produce a highly efficient absorbent product. No doubt other materials with a content similar to footwear will also be suitable raw materials for processing into a highly absorbent fill material. But, footwear is readily available at little or no cost and when sorted and proportionally mixed according to the embodiments of the process is suitable feedstock for the process. Therefore, the embodiments in this specification will be described using footwear as the raw material. However, any materials that will produce the desired absorbency of the finished material will be suitable as raw material inputs to the process.

Environmentally sound disposal of footwear is expensive. Footwear is bulky, resistant to decomposition, and creates dioxins and other toxic compounds when burned.

Attempts have been made to use the rubber constituent of footwear. For example the ground rubber is used to create recreational sports playing surfaces, doormats, new footwear soles, and other recovered rubber products. These products, however, consume only a very small percentage of rubber in discarded footwear. Moreover, the nonrubber portion of the footwear is considerable and is most often disposed of in refuse disposal sites.

The embodiments of the process described in this specification create a new avenue for recycling a greater volume of discarded footwear and the manufacture of new and useful absorbent products.

Embodiments of the process use the entire footwear. Other embodiments use parts of the footwear.

Certain embodiments described in this specification control the finished product (“product of the process”) characteristics by controlling proportions of the footwear categories introduced into the process feedstock. The proportions may be tailored to (a) vary the finished product absorbency, (b) to avoid its clumping, and (c) to achieve other desired characteristics of the finished product. In other embodiments, process variables other than the proportions of the categories of footwear may also be manipulated to influence the finished product's characteristics.

An embodiment of the process does not deconstruct the footwear into its constituent materials—this would raise the cost of producing the product. It shreds or grinds the entire footwear and retains all of the constiututes in a heterogeous mass. In this specification the terms “shred” and “grind” are used interchangeable. Another embodiment does not first grind all of the footwear categories together and then separate the constituent materials of the footwear. It grinds each category of footwear separately and then proportions the separate grinds into a single mix. Another embodiment grinds all of the footwear categories together and then separates the constituent material by, for example, blowing air through the ground material, which allows the heavier particles of ground material to fall out of the air stream before the lighter particles fall out. The individual particles are then collected in separate containers.

Footwear sent to a disposal or recycling facility is a mixture of many different kinds of footwear. Some examples of footwear materials used as the raw material for the process are: leather, man-made material, rubber, cloth, and plastic. The footwear raw material used in the process described in this specification is sorted, often by hand, into different categories (may also be referred to as classes, types, or categories) of footwear based upon the primary composition of the footwear. Examples of categories into which the footwear is sorted comprises (a) women's regular; (b) women's dark; (c) men's; (d) children's; (e) tennis; and (f) winter boot footwear.

The women's regular footwear category is comprised of women's man-made, white leather, and nonrubber flip flop footwear. This category does not include women's tennis footwear, women's jelly footwear (i.e. predominantly all rubber flip flops), or any women's footwear with a heel over ¾ inch. The nonrubber flip flops are made of cork, man-made material, and some leather. The women's dark footwear category is comprised of women's dark leather footwear with heels less than ¾ inch, such as women's Doc Martins and ankle high footwear. The men's footwear category is comprised of men's all dark leather footwear and some higher boots but no cowboy boots. The children's footwear category is comprised of every kind of children's footwear, except Jellies and winter boots. Children's footwear in relatively low in leather content. The tennis footwear category is comprised of women's and men's predominantly white leather footwear. The winter boot footwear category is comprised of cowboy boot, jelly, and cloth slipper footwear.

The footwear categories are proportionally mixed together to produce a finished product with desired characteristics. Examples of the proportional composition (the “blend”) of an embodiment of the feedstock used in the process is (a) about one part women's regular; (b) about one part women's dark; (c) about two parts men's; (d) about one part children's; (e) about one part tennis; and (f) about one part winter boot footwear. Another embodiment of the blend is (a) about one part women's regular; (b) about two parts women's dark; (c) about one part men's; (d) about one part children's; (e) about one part tennis; and (f) about one part winter boot footwear.

An embodiment of the finished product is comprised of about 43% man made materials, about 36% leather, and about 21% wool and cotton. Another embodiment of the finished product is comprised of about 38% man made materials, about 32% leather, about 18% wool and cotton, and 12% polypropylene. This second blend is generally used only in socks and booms.

The composition of the categories and the blend of the categories affects the characteristics of the finished product. For example, a blend short on floatable material such as wood and cork might be fine for products used on factory floors. It would not be good for products used to contain oil spills on the surface of a water body which requires a floatable product. The amount of rubber in the finished product is used to impede its clumping. Clumping is a problem with sticky substances like petroleum products. For other more viscous fluids it is less of a problem. Another example of a blend that works well for an end user product to remove petroleum products spilled on a water body does not work to remove fluids from a factory floor. The blend for the factory floor must be lower in leather because leather becomes slimey when wet and creates a slip and fall hazard. On the other hand a higher leather blend finished product provides more absorbency for removing spills from a water body and the slimeyness is of no concern. Addition of ground polypropelene, while not necessary for the finished product of the process, does provide separation of the constituents of the finished product. The rubber content also keeps the finished product from clumping.

The various characteristics of a finished product do not manifest themselves in a precise manner. The process is a recycling process that uses a mixed batch of raw material. The characteristics vary over a somewhat wide range since the process does not, for example, use a precisely measured amount of rubber, cork, leather, wood, cloth, and so forth. Wide tolerances are acceptable for the uses to which these products are put. The nature of the process (which utilizes equipment made for recycling waste) and its composition of feedstock (which is a batch of shoes of all kinds sorted and blended in a rough fashion) does not lend itself to precision blends of finished product. And, therefore the blends mentioned in this specification are not meant to be precise and need not be so to produce a highly absorbent product suitable for its purposes.

The attributes of the finished product is a function of the sorting of the footwear into categories and the proportional mixing of the categories of footwear. Use of the entire footwear increases the end product's absorptive ability, low density, floatability, and ability to capture and entrain air. Adjustment of the proportions of the footwear categories and/or the particulate size of the intermediate feedstock further affects the finished product characteristics.

The finished product may be sold at a relatively low price point due to the low cost of both the raw footwear materials and the recycling process. One embodiment of the finished product is processed to primarily function as an absorptive fill for removal of liquid waste such as water, oil spills, and sewage. Another embodiment of the finished product is processed to primarily function as a potting agent for agriculture.

Naturally, an important property of an absorbent material for cleaning up spills on water is its ability to float. The finished product of this process floats without any further processing other than described in this specification, except for bagging into various shapes. Other commercially available absorbent materials used for spill clean-up on water, such as lakes, ponds, rivers, and oceans, add polypropylene and cellulose for flotation. As mentioned before, polypropylene is expensive and the use of cellulose is frowned upon because it uses valuable trees. The floatable material made by the process embodiments described do not need the addition of polypropylene or cellulose to clean up spills.

The finished product may be treated with additives to enhance or alter its properties and characteristics. The finished product may be sprayed with an additive such as soap or another surfactant to assist in the break-up of clumped, spilled material into small globules or particles. Reduction of globule size, especially of petroleum products, is important because as the globule size decreases the ability of the absorbent product to absorb the spilled material increases. However, the finished product made by this process is highly absorbent without the addition of surfactants because the rubber content interferes with clumping of the other constituents of finished product. This appears to offset the need to reduce the globule size of the spilled material. Furthermore, the finished product absorbs more oil than water, which makes it a highly efficient product for oil spills.

An embodiment of the process of recycling various types of footwear comprises (a) grinding the footwear raw material into heterogeneous batches of specific types of footwear and (b) controlling the proportion of each type of footwear that enters the process. The result is that the absorbency of the finished product is a function of the proportions of each category of material introduced into the process stream. The finished product is a mixture of small heterogeneous granular particulate and loose fiber material. The granular particulate is ground and screened to be no larger than one inch across any of its spatial axes with an average particulate size smaller than the one inch upper limit.

An embodiment of a finished product is comprised of ground footwear of a composition specific to its application. The ground footwear finished product may therefore be comprised of (a) polyurethane, elastane, polyvinyl chloride, polyethylene, ethylene vinyl acetate, and other polymeric material; (b) non-polymeric material, such as natural and synthetic rubber, including but not limited to, nitrile rubber, neoprene, hypalon, and butyl rubber; (c) natural and synthetic fabrics, including but not limited to, jute, cotton, polyester, nylon, rayon, and denim; (d) leathers; (e) cork; (f) wood; (g) natural fibers; and (h) other footwear constituents.

Process Steps

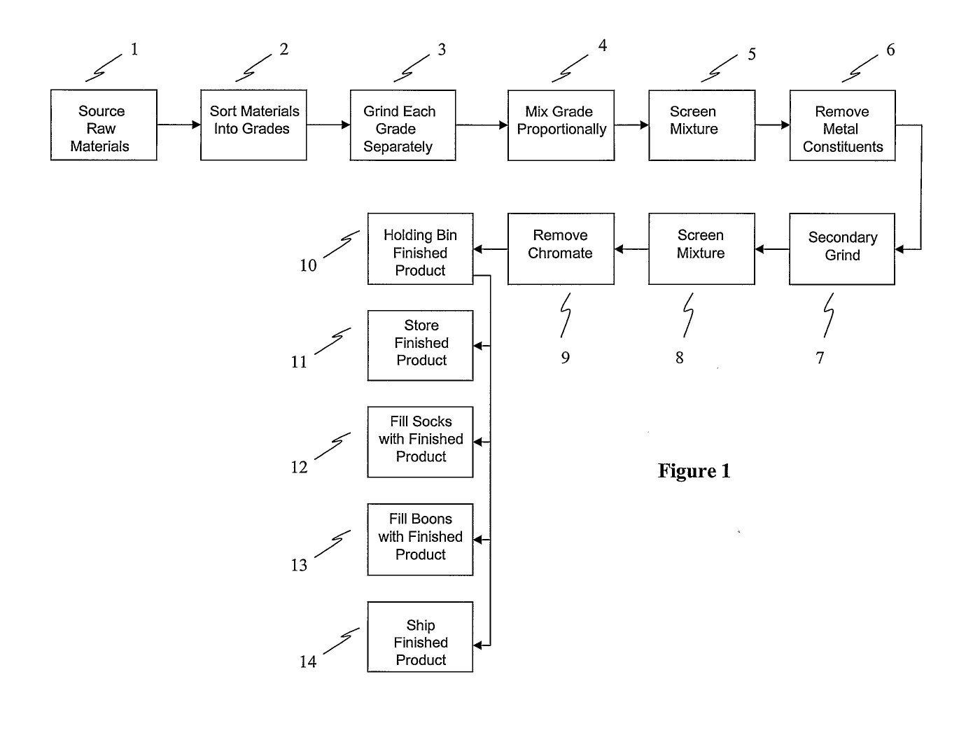

An embodiment of the process is illustrated in FIG. 1. The numbers of the steps in this paragraph correspond to like numbers if FIG. 1. It comprises the steps of (1) sourcing raw materials; (2) sorting the raw materials into categories; (3) grinding each raw material category separately; (4) mixing the ground categories of raw materials together in predetermined proportions; (5) screening the proportionally mixed raw material to a predetermined maximum particle size; (6) removing metal constituents from the screened raw material; (7) grinding the demetalized raw materials; (8) screening the demetalized raw material to a predetermined maximum particle size; (9) removing chromate from the screened raw materials to a predetermined maximum level of chromate; (10) containing the finished product in a holding bin; and (12, 13, and 14) forming the finished product into bulk lots, booms, socks, pads, or other configurations. The finished product is primarily a fluffy fill material. It is comprised of (a) loose fiber material and (b) particles of leather, canvas, rubber, and plastic of a size larger than the fiber material.

Another embodiment of the process comprises the steps of (a) sourcing raw materials; (b) sorting the raw materials into categories; (c) grinding each raw material category separately; (d) mixing the ground categories of raw materials together in predetermined proportions; (e) screening the proportionally mixed raw material to a predetermined maximum particle size; (f) removing metal constituents from the screened raw material; (g) grinding the demetalized raw materials; (h) screening the ground demetalized raw material to a predetermined maximum particle size; (i) removing chromate from the screened raw materials to a predetermined maximum level of chromate.

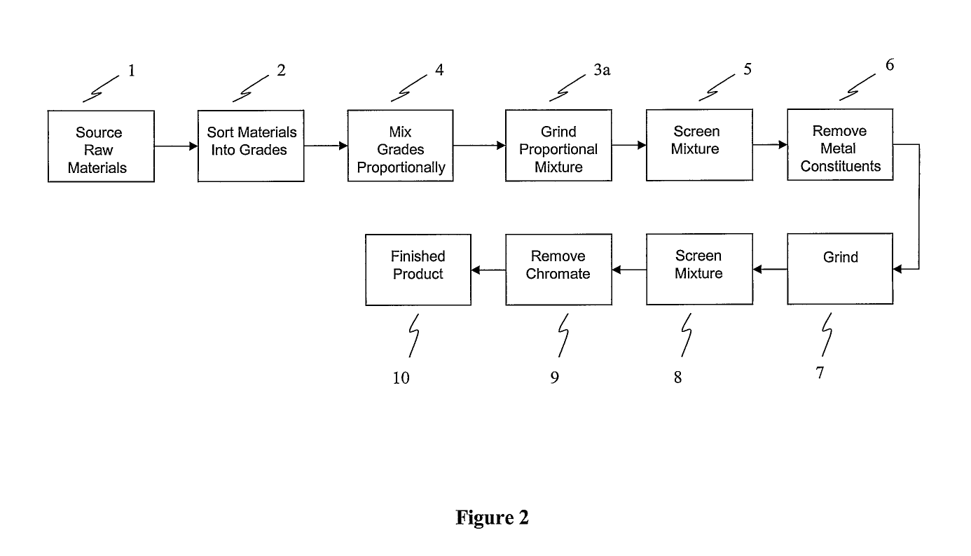

Another embodiment of the process is illustrated in FIG. 2. The numbers of the steps in this paragraph correspond to like numbers if FIG. 2. It comprises the steps of (1) sourcing raw materials; (2) sorting the raw materials into categories; (4) mixing the sorted categories of raw materials together in predetermined proportions; (3a) grinding the proportionally mixed raw materials; (5) screening the proportionally mixed ground raw material to a predetermined maximum particle size; (6) removing metal constituents from the screened raw material; (7) grinding the demetalized raw materials; (8) screening the ground demetalized raw material to a predetermined maximum particle size; (9) removing chromate from the screened raw materials to a predetermined maximum level of chromate.

A further embodiment of the process comprises the steps of (a) sorting raw materials into categories; (b) mixing the sorted categories of raw materials together in predetermined proportions; (d) grinding the proportionally mixed raw materials to a predetermined maximum particle size; (e) removing metal constituents from the ground raw materials; and (f) removing chromate from the ground raw materials to a predetermined maximum level of chromate.

An embodiment of the process also comprises the step of spraying the raw material with a surfactant. In one embodiment the surfactant is soap. An embodiment uses footwear as the raw material.

Sourcing Footwear Raw Materials

The process uses footwear as the raw material. The raw material is gathered from many sources, such as footwear overstock of retailers and manufacturers, footwear disposed of by end users in a disposal site, footwear donated to charitable organizations in excess of the amount it is able to distribute to the needy. The footwear raw material is relatively inexpensive to procure. The footwear raw material once obtained for the process is referred to in this specification as the sourced raw material and is the feedstock entered into the process. The feedstock is converted by each step of the process on its way to the finished product. Other embodiments may substitute non-footwear materials, depending upon availability, cost, and composition.

Sorting Footwear into Categories

The footwear raw material is sorted into categories. Sorting appears, at this time, to be most economically done by hand labor. However, optical scanners, other recognition devices, or any other sorting devices may be used to sort the raw materials.

The number of categories into which the raw material is sorted depends upon the characteristics desired for the finished product and the level of refinement of those characteristics. One embodiment of the process sorts the raw material into 6 categories. The composition of footwear varies widely. For example, some footwear is primarily constructed of one of the following materials: (a) leather; (b) canvas; (c) rubber; and (d) plastic.

Shredding Footwear Feedstock

The footwear is shred by a shredder/grinder and in the process of shredding the various constituents of the footwear are mixed. The size of the shredded material must be small enough that the constituents of feedstock are mixed to a roughly even distribution. Many different grinder/shredders are commercially available to grind/shred the feedstock. For example, the MS-2817 industrial shredder manufactured by Mitts & Merrill, Inc. is suitable for this purpose.

In one embodiment, each raw material category is separately shredded/ground. The shredded categories of sorted raw materials chosen for the feedstock are mixed in proportions predetermined to make a finished product with roughly the desired characteristics. In another embodiment, the various categories are first mixed together in the predetermined proportions and then the mixed material is run through the shredder.

Screening the Shredded Footwear

In one embodiment, the size of the particles exiting the shredder/grinder are less than 1.0 inch. The exiting particle size is achieved by a screen on the output of the shredder. The spacing of the screen lattice is equivalent to the maximum size of the desired piece of the shredded material. The effect is that any material larger than the screen size can not exit the shredder/grinder until it is ground down to the maximum allowable size. Screens of many different sizes and shapes are commercially available and can be made to order.

Mixing the Footwear Categories

The various categories of raw materials are mixed together at some point in the process in predetermined proportions.

Metal Removal

Some footwear contains metal for arch supports, toe protection, and other things. The metal constituents of footwear need to be removed from the feedstock because, among other things, it increases the weight of the finished product, decreases its buoyancy, may be left in the environment when the material is discarded, and is a recyclable material of some value. In one embodiment, the metal is pulled out of the shredded raw material by a magnet. The magnet may be positioned over, under, or in some other position relative to a conveyor belt on which the shredded/ground material is carried from one stage of the process to the next. Periodically, the collected metal is dropped into a storage bin for later disposition. An electromagnet or a permanent magnet works for collecting the metal. An electromagnet may be energized during collection and de-energized periodically to allow the collected metal to drop into a collection bin. Commercially available permanent magnets are equipped with a device to remove the collected metal for storage in a collection bin. Both electromagnets and permanent magnets equipped with removal devices suitable for the process described are available from Eriez Magnetics of Erie Pa. In one embodiment the metal is extracted after the mixed categories of footwear are shredded/ground and screened. At this point of the process the metal is no longer bound to the other footwear constituents and is ground small enough that the magnet can extract it from the ground mixture. Metal extraction can be accomplished at other points in the process, such as after the second grind of the material. This may be a less efficient point for extraction because after the second grind the particle size of the mixture is relatively fine and separation of the fine metal particles may be more difficult and create some fine metal dust. Moreover, the second grind may be set to run at a lower torque and faster speed than the shredder/grinder, which is not conducive to cutting metals. Metal can also be extracted from each category of footwear separately. In this case each individual footwear category is shredded and then the various demetalized categories are proportionally mixed and fed to the next process step.

Secondary Grinding Of Footwear Feedstock

The purpose of grinding the demetalized material is to further reduce the particle size to a point that makes a more absorbent and workable finished product. The finished product is more absorbent because more surface area is created with a given mass of mixed footwear than with larger particles. The finished product is also more workable. For example, it is easier to pack the finished product into booms, socks, and other shapes for differing end uses. And, as previously mentioned, the secondary grinder may be set to run at a lower torque and faster speed than the shredder/grinder. The shredder/grinder has a tougher job. It must grind a large batch of whole footwear. This requires a heavy duty grinder with a heavy current draw to drive a high torque, low speed, shredder cutter. Likewise, the screen on the output of the secondary grinder may be of a lighter construction than the screen used for the shredder/grinder. Therefore, the second screen is most likely less expensive than the shredder/grinder screen and may last longer. Grinders sufficient to accomplish the secondary grinding step of the process are commercially available from a number of sources. An example of such a grinder is available from the Cumberland line of grinders sold at Polymer LLC, located at 471 Rell Need Boulevard, Naples, Fla. 34110.

Screening the Secondary Grind

In one embodiment, the size of the particles exiting the secondary grinder are less than ⅛^{th} inch. The particle size exiting the secondary grinder is achieved by a screen on the output of the secondary grinder. The spacing between the screen lattice is equivalent to the maximum size of the desired particle. The effect is that any material larger than the screen size can not exit the secondary until it is ground down to the maximum allowable size. Screens for the secondary grinder are of many different sizes and shapes and are commercially available and can be made to order.

Removing Chromate

Chromate is used in the process of tanning leather and a portion of it remains in the leather after tanning, although most is washed out during the process. An embodiment of the process removes chromate from the tanned leather constituents of the feedstock to less than 5 parts per million.

The common name of one form of chromate used for tanning is chromium sulfate, a salt. Its chemical description is Cr2(So4)3. Chromium sulfate is available from Elementis LTP L.P., 546 South Water Street, Milwaukee, Wis. 53204. According to the Elementis MSDS, its chromium sulfate contains 38%-to 56% moisture. Chromate is stable under normal conditions. Chromium sulfate is considered a hazardous substance in quantities over 1000 pounds under the Comprehensive Environmental Response, Compensation, and Liability Act. And chromium sulfate exceeds the Resource Conservation and Recovery Act extraction procedure limit of 5 parts per million for total soluble chromium sourced from Elementis LTP L.P., according to its MSDS.

Chromate removal is most efficiently accomplished as the last step in the process. The removed chromate is usually in the form of flakes. Removal at this stage of the process seems to be facilitated by the small particle size of the feedstock exiting the secondary grinding stage. It appears that the chromate flakes are less attached to the feedstock mass at this stage and therefore more susceptible to being drawn out of the undifferentiated mass of feedstock.

It is known that chromate is a paramagnetic material. A paramagnetic material is weakly drawn to a source of a magnetic field. Once the magnetic field ceases to exist, the chromate ceases to exhibit magnetic properties—these properties only exist under the influence of the field. Therefore, a sufficient magnetic field in the space around the chromate flakes will draw the flakes out of the feedstock. The required strength of the field may depend upon (a) the proximity of the chromate to the magnetic source, duration of time it is exposed to the field, and its moisture content and (b) the moisture content of the feedstock, its particle size, the level of static charge within it, and its degree of clumping.

It is likely that the moisture content of the chromate retards its removal due to sticking of the chromate to the other constituents of the feedstock. If the moisture content is sufficiently high to cause this effect, heating the feedstock to dry it prior to, or simultaneously with, exposing it to a magnetic field will remedy the problem. The temperature and duration of the heating step will vary depending upon the amount of moisture in the feedstock. Air drying will also accomplish the goal of moisture reduction.

Heat can also lessen, or remove all together, static within the entire feedstock mass. Static may also make it difficult for the magnetic field to remove chromate flakes from the feedstock due to the stickyness of all of the particles within the feedstock to one another, including the chromate.

In general, control of moisture in the feedstock throughout the process steps may be necessary to increase its workability as it cycles through its various stages, avoid clumping, and reduce static charges within the feedstock.

The level of the magnetic field may need to be varied to adjust for some of the variables in the condition of the feedstock. This is true regardless of whether the process is run in a batch or continuous mode.

After the secondary grind and secondary screening of the feedstock, an embodiment of the feedstock is spread onto a moving conveyor belt. A magnetic device is placed in close proximity to the conveyor belt. The magnetic device creates a magnetic field that envelopes the feedstock and draws-out the chromate flakes. The magnet may be situated anywhere in proximity to the conveyor belt to the extent necessary for chromate to be within its magnetic field. The magnet may be what is referred to as a cross belt magnet, which is a magnet that is at an angle to the movement of the conveyor belt—most often perpendicular. The magnet may be also be a part of the head pulley of the conveyor belt. Cross belt magnets and head pulley magnets are available from Eriez Magnetics, Erie Pa.

In one embodiment, a cross belt magnet throws the chromate flakes off to the side of the conveyor belt into a container for reclamation or disposal. In another embodiment an electromagnet is turned off periodically to allow the collected chromate to drop into a container. The magnet required for chromate removal can be of a lesser field strength than the magnet required for metal removal.

Containing Finished Product

The finished product is the resultant feedstock after the chromate is removed. It is a heterogeneous mass of fill material composed of vary quantities of rubber, cloth, leather, and possibly other constituents depending upon the nature of the sourced footwear. The finished product can be off-loaded from the process into a suitable holding bin for later conversion into end user products. Alternatively, the finished product can be directly filled into end user products such as booms, sock, and pads. Conversion into end user products can be the final step in a continuous process beginning with sourcing footwear to creating the end user product.

Forming Finished Product

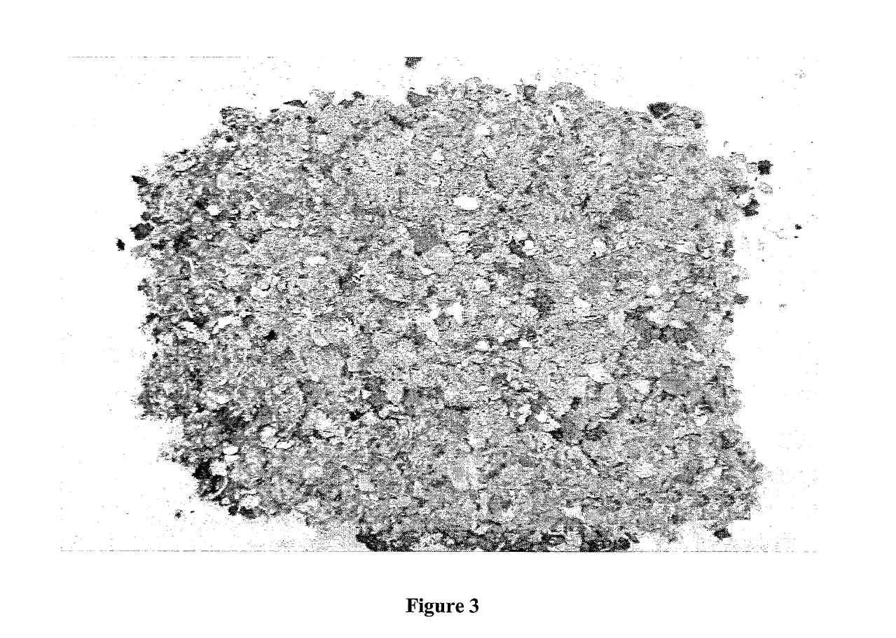

The finished product itself is an end user product suitable for absorbsion of fluids. An embodiment of the finished product made by the process is photographically shown in FIG. 3. The highly absorbent finished product is often used as an absorbent material in booms, socks, pads, or other configurations.

The heterogeneous nature of composition of the finished product creates a product that absorbs a large array of liquids. The absorbency of the finished product, as previously noted, is a function of the proportions of the categories of materials making up the end product's final blend. Therefore, the characteristics of the finished product can be modified to some degree to suit the specifications of a buyer. Tailoring the composition of the feedstock to achieve a certain characteristic profile of finished product may be economically accomplished one or more of the steps of modifying the (a) make-up of the categories of footwear and sorting the footwear accordingly, (b) proportions of the footwear categories to create the feedstock mix, and (c) particle size.

An embodiment of the finished product is a blend of (a) leather, cotton, and some synthetics, which are ground into a fluff absorbent mix and (b) a small amount of treated leather, cork, and natural rubber abrasive to facilitate drainage.

Generally, end users are seeking the most absorptive finished product possible. In one embodiment, the mix of categories of materials creates a product that is capable of absorbing more fluids than it's own weight. Typical fluids that are a target for clean-up are oil, grease, oil based fluids, mixtures of soluble oils, water acids, paint, ink, water, other fluids, or a blend of the foregoing. Besides removal of pollutants from water bodies, a frequent reason for use of absorbents is to reduce slipping hazards and flash oil fires, as well as keeping floors clean and dry.

The finished product is a low in dust. It is a low spontaneous combustion material. It can absorb three times its weight. Up to 90% of the absorbed fluid can be wrung out, the wrung-out product can be reused, and the wrung-out fluid can be recycled. Its granule size can be varied by the process. The product can be incinerated—clay cannot. The incinerated product consists of less than 2.5% ash. And it is safe when mixed with hydrofluoric acid.

The product can be formed into booms, socks, pads, and other forms. The booms, socks, and pads are forms of containers for containing the finished fill product. The container is usually made of cloth to allow the fluid to permeate the container and be absorbed by the finished product within. Cloth can also be sewn in many different shapes to allow the product to conform with various surfaces and be made to encircle surfaces for containment within a designated area. Without a containment form, the finished fill product could spread to areas where it is not wanted and it could move away from the site of the offending fluid and fail to absorb it. A cloth container allows the user to wring out the absorbed fluid and use the finished product filled boom, sock, pad, or other form again. The socks are intended to absorb fluids in a confined area, whereas booms are generally used for confining and absorbing large spills. Pads work on water borne spills, as well as for confined areas. Socks, booms, and pads can be made in various configurations, lengths, cross sections, and perimeters.

The process described can be implemented using a common array of recycling equipment. The process equipment includes containers for the sourced footwear, containers for temporary storage of footwear sorted into categories, a mixing bin for proportionally mixing various categories of footwear, a conveyor for moving the mixed categories to a shredder, a shredder for deconstructing the feedstock, a screen to limit the size of the feedstock that exits the shredder, a source of heat to remove moisture from the feedstock at various stages in the process, a magnet to remove metal from the shredded feedstock, a conveyor to move the shredded feedstock through the magnet's magnetic field and to advance the feedstock to a second stage grinder, a means of removing the collected metal from the magnet, a second stage grinder, a screen to limit the size of the feedstock that exits the second stage grinder, a magnet to remove metal from the secondarily ground shredded feedstock; a conveyor to move the secondary ground feedstock through the magnet's magnetic field and to advance the feedstock to a containment vessel for storage of the finished product.

Although the foregoing written description describes one or more embodiments of the process and its product, the description may also suggest modifications of the process and its product to one of ordinary skill in the art that do not depart from the spirit and scope of the process and its product. The embodiments are intended to be limited only by the scope of the claims.

What is claimed is:

1. A process of making an absorbent, comprising the steps of (a) sorting footwear into categories; (b) proportionally mixing categories of footwear; (c) shredding footwear; (d) removing metal and chromate from the footwear.

2. The process of claim 1, wherein the categories are selected from (a) women's regular; (b) women's dark; (c) men's; (d) children's; (e) tennis; and (f) winter boot footwear.

3. The process of claim 2, wherein the women's regular category is comprised of women's man-made and white leather footwear, excluding women's tennis footwear, women's jelly footwear, any women's footwear with a heel over ¾ inch.

4. The process of claim 2, wherein the women's dark category is comprised of women's dark leather footwear with heels less than ¾ inch.

5. The process of claim 2, wherein the men's footwear category is comprised of men's all dark leather footwear and some higher boots, excluding cowboy boots.

6. The process of claim 2, wherein the children's footwear category is comprised of every kind of children's footwear.

7. The process of claim 2, wherein the tennis footwear category is comprised of predominantly all white leather footwear.

8. The process of claim 2, wherein the winter boot footwear category is comprised of cowboy boots, jellies, and cloth slippers.

9. The process of claim 1, wherein the proportions of the mixed categories are comprised of (a) about 1 part women's regular; (b) about 1 part women's dark; (c) about 2 parts men's; (d) about 1 part children's; (e) about 1 part tennis; and (f) about 1 part winter boot footwear.

10. The process of claim 1, wherein the proportions of the mixed categories are (a) about 1 part women's regular; (b) about 2 parts women's dark; (c) about 1 part men's; (d) about 1 part children's; (e) about 1 part tennis; and (f) about 1 part winter boot footwear.

11. The process of claim 1, comprising footwear shred into particles of footwear constituents of a size that distribute relatively evenly throughout the mixture.

12. The process of claim 1, wherein removing metal and chromate from the footwear comprises subjecting the metal and chromate to a magnetic field.

13. The process of claim 1, wherein removing chromate from the footwear comprises subjecting the shredded footwear optionally to (a) a hot water rinse; (b) a solution in which chromate is soluble; and (c) both of the foregoing.

14. The process of claim 1, also comprising adding a surfactant to the footwear.

15. The process of claim 14, wherein the surfactant is added after the metal and chromate are removed from the footwear.

16. The process of claim 11, also comprising adjustment of the not to exceed predetermined size of the particles is made to vary the characteristics of the finished product.

17. The process of claim 11, wherein the particles of the footwear constituents comprise particles that do not exceed a predetermined size.

18. The process of claim 11, wherein the particles of the footwear constituents are comprised of particles that do not exceed one inch.

19. The process of claim 11, wherein the particles of the footwear constituents are comprised of particles that do not exceed one one-eighth of an inch.

20. The process of claim 12, comprising removal of chromate to less than 5 parts per million.

21. The process of claim 1, comprising a first shredder and a secondary shredder.

22. The process of claim 12, comprising removing chromate after the step of performing the second shred of the feedstock.

22. The process of claim 21, comprising optionally removing moisture from the feedstock prior to, during, or after the secondary shred.

23. The process of claim 22, comprising optionally removing moisture by heat or by air drying.

24. The absorbent product made by the process of claim 1.

25. A process of making an absorbent, comprising (a) establishing categories of footwear; (b) sorting footwear into categories; (c) separately shredding each category of footwear; (d) sizing each particle of the separately shredded categories of footwear to less than a predetermined dimension; (e) proportionally mixing the separately shredded categories of footwear; (f) removing metal from the proportionally mixed footwear; (g) shredding the demetalized mixed footwear; (h) sizing each particle of the shredded demetalized mixed footwear to less than a predetermined dimension; (i) removing moisture from the demetalized mixed footwear; and (g) removing chromate from the dimensioned demetalized footwear.

26. The absorbent product made by the process of claim 25.

27. The process of making an absorbent, comprising (a) establishing categories of footwear; (b) sorting footwear into categories; (c) proportionally mixing the categories of footwear; (d) shredding the proportionally mixed footwear; (e) sizing each particle of the shredded footwear to less than a predetermined dimension; (f) removing metal from the dimensioned footwear particles; (g) shredding the demetalized footwear; (h) sizing each particle of the shredded demetalized mixed footwear to less than a predetermined dimension; (i) removing moisture from the dimensioned footwear particles; and (g) removing chromate from the demoisturized footwear.

28. The process of claim 27, comprising the sorted categories of footwear mixed together in proportions predetermined based upon a desired characteristic of the finished product.

29. The process of claim 27, comprising footwear shred into particles of footwear constituents of a size that distribute relatively evenly throughout the mixture.

30. The process of claim 27, wherein removing metal and chromate from the footwear comprises subjecting the metal and chromate to a magnetic field.

31. The process of claim 27, wherein removing chromate from the footwear comprises subjecting the shredded footwear optionally to (a) a hot water rinse; (b) a solution in which chromate is soluble; and (c) both of the foregoing.

32. The process of claim 27, also comprising adding a surfactant to the feedstock footwear.

33. The process of claim 32, comprising adding the surfactant after the metal and chromate are removed from the footwear.

34. The process of claim 27, comprising adjustment of the not to exceed dimension of the particles is based upon a desired characteristic of the finished product.

35. The process of claim 27, wherein the particles of the footwear constituents are comprised of particles that do not exceed one inch.

36. The process of claim 27, wherein the particles of the footwear constituents are comprised of particles that do not exceed one-eighth of an inch.

37. The process of claim 27, comprising removal of chromate to less than 5 parts per million.

38. The process of claim 27, comprising a first shredder and a secondary shredder.

39. The process of claim 38, comprising removing chromate after the step of performing the second shred of the feedstock.

40. The process of claim 38, comprising optionally removing moisture from the feedstock prior to, during, or after the secondary shred.

41. The process of claim 27, comprising optionally removing moisture by heat or by air drying.

42. The absorbent product made by the process of claim 27.

43. The process of making an absorbent, comprising proportional mixing material selected from polyurethane, elastane, polyvinyl chloride, polyethylene, ethylene vinyl acetate, and other polymeric material; nitrile rubber, neoprene, hypalon, butyl rubber, and other non-polymeric material; jute, cotton, wool, polyester, nylon, rayon, denim, canvas, other fibers; leather; cork; wood; and mixtures of the foregoing, into a heterogeneous mixture of a grannular mass of particulate and loose fiber.
